(19) United States
(12) Patent Application Publication
(10) Pub. No.: US 2024/0342655 A1
(43) Pub. Date: Oct. 17, 2024

(54) Catalytic Article for Ammonia Slip Removal From Diesel Exhaust Aftertreatment Systems With Low Weight and Faster Heating

(71) Applicant: Umicore AG & Co. KG, Hanau-Wolfgang (DE)

(72) Inventors: Arkady Kustov, Frederiksberg C (DK); Preben Nissen, Frederiksberg (DK)

(21) Appl. No.: 18/691,962

(22) PCT Filed: Sep. 8, 2022
(86) PCT No.: PCT/EP2022/074980

§ 371 Date: Mar. 14, 2024

(30) Foreign Application Priority Data
Sep. 24, 2021 (EP) 21198821.7

(51) Int. Cl. B01D 53/94; B01J 21/06; B01J 23/42; B01J 29/072; B01J 29/76; B01J 35/00; B01J 35/58; B01J 37/00; F01N 3/20; F01N 3/28

(52) U.S. Cl. CPC B01D 53/9436; B01D 53/9418; B01J 21/063; B01J 23/42; B01J 29/072; B01J 29/763; B01J 35/19; B01J 35/58; B01J 37/0018; F01N 3/2066; F01N 3/2828; B01D 2251/2062; B01D 2255/1021; B01D 2255/20738; B01D 2255/20761; B01D 2255/50; B01D 2255/9022; B01D 2257/404; B01D 2257/406; B01D 2258/012; F01N 2510/063; F01N 2510/0684; F01N 2610/02

(57) ABSTRACT

The present invention provides a catalytic article for the removal of nitrogen oxides and ammonia from exhaust gas of lean combustion engines which heats up quickly to its operation temperature and shows a better performance. Another aim of the present invention is to provide a system for the purification of exhaust gases emitted from lean combustion engines comprising said catalytic article. The catalytic article comprises a corrugated glass fiber substrate, a first washcoat, comprising at least one platinum group metal and/or at least one platinum group metal oxide, supported on a refractory metal oxide support, and optionally at least one binder, wherein said first washcoat is affixed to the glass fibers of the nonwoven corrugated glass fiber substrate, such that areas consisting of particles of the first washcoat alternate with void spaces, and a second washcoat, comprising an SCR catalytically active composition and optionally at least one binder, wherein said second washcoat is affixed to the glass fibers of the nonwoven corrugated glass fiber substrate, and wherein said second washcoat covers the areas consisting of particles of the first washcoat and the void spaces. The SCR catalytically active composition preferably comprises molecular sieves.

The present invention provides a catalytic article for ammonia slip removal from diesel exhaust aftertreatment systems with light weight, faster heating and better performance, a method for making said catalytic article, and uses of the catalytic article.

Modern internal combustion engines require the use of catalytic aftertreatment systems to reduce harmful emissions and respect the new legislation standards.

In addition to carbon monoxide CO, hydrocarbons HC, and nitrogen oxides NOₓ, the raw exhaust gas of diesel engines contains a relatively high oxygen content of up to 15 vol %.

Particle emissions that predominantly consist of soot residues and possibly organic agglomerates and originate from a partially incomplete fuel combustion in the cylinder of the engine, are contained as well.

While diesel particulate filters with and without a catalytically active coating are suitable for removing particle emissions, carbon monoxide and hydrocarbons are rendered harmless by oxidation on a suitable oxidation catalyst. Oxidation catalysts are described extensively in the literature. They are, for example, flow-through substrates, which carry precious metals, such as platinum and palladium, as essential, catalytically active components on large-area, porous, high-melting oxides, such as aluminum oxide.

Nitrogen oxides may be converted on an SCR catalyst in the presence of oxygen to nitrogen and water by means of ammonia. SCR catalysts are described extensively in literature as well. They are generally either so-called mixed oxide catalysts, which contain, in particular, vanadium, titanium, and tungsten, or so-called zeolite catalysts, which comprise a metal-exchanged, in particular small pore zeolite. SCR-catalytically-active materials may be carried on flow-through substrates or on wall-flow filters.

The ammonia used as reducing agent may be made available by feeding an ammonia precursor compound into the exhaust gas which is thermolyzed and hydrolyzed to form ammonia. Examples of such precursors are ammonium carbamate, ammonium formate and preferably urea. Alternatively, the ammonia may be formed by catalytic reactions within the exhaust gas.

In order to improve the conversion of nitrogen oxides at the SCR catalyst, it may be necessary to feed in the ammonia in a quantity that is approximately 10 to 20% higher than the quantity required, i.e., in an overstoichiometric quantity. This in turn leads to unreacted ammonia in the exhaust gas, which is undesirable in view of its toxic effects. Ammonia emissions are increasingly limited in the exhaust gas legislation.

To avoid ammonia emissions, so called ammonia slip catalysts (ASC) have been developed. These catalysts usually comprise an oxidation catalyst for the oxidation of ammonia at temperatures as low as possible. Such oxidation catalysts comprise at least one precious metal, preferably a platinum group metal (PGM), like for example palladium and, in particular, platinum. However, oxidation catalysts comprising precious metals oxidize ammonia not only to nitrogen (N₂) but also to harmful species like dinitrogen oxide (N₂O) and nitrogen oxides (NOₓ) as well. The oxidation of NH₃ to nitrogen, N₂O, NO or NO₂, respectively, is shown in equations (1) to (4):

| | |
|---|---|
| 4 NH₃ + 3 O₂ → 2 N₂ + 6 H₂O | (1) |
| 6 NH₃ + 6 O₂ → 3 N₂O + 9 H₂O | (2) |
| 4 NH₃ + 5 O₂ → 4 NO + 6 H₂O | (3) |
| 4 NH₃ + 7 O₂ → 4 NO₂ + 6 H₂O | (4) |

The selectivity of the ammonia oxidation towards nitrogen can be improved by combining the oxidation catalyst with an SCR catalyst. Such combination can be performed in different ways, for example both components can be mixed and/or they can each be present in a separate layer on a carrier substrate. In case of a layered arrangement, the SCR layer is usually the upper layer and is coated on the oxidation layer which is the lower layer.

In order to achieve high NOₓ conversions, high amounts of active SCR material are needed within the ASC. On the other hand, a high amount of SCR material covering the PGM component would significantly reduce its ammonia conversion activity. Thus, there is a need to solve this trade-off.

Known ASC catalysts are usually coated on a monolithic carrier substrate like a flow through substrate or a wall flow filter. It deals with layered catalysts that are coated on the walls of ceramic substrates. Most commonly, the substrates are cordierite or corrugated titania-based substrates. Such a catalytic article, which consists of the catalyst and the substrate, is characterized by increased pressure drop and high specific heat capacity mass. A higher specific heat capacity means that a longer period of time is required for the catalyst to heat up to its operational temperature during cold start of the engine and during fast transients, which limits the efficiency of the catalyst in ammonia removal. Usually, temperatures above 200 to 250° C. are needed for the ammonia slip catalyst to operate efficiently.

Many known catalytic articles comprise both a selective catalytic reduction catalyst (SCR catalyst) for the reduction of nitrogen oxides and an ammonia slip catalyst (ASC) for the removal of excess ammonia.

WO 2018/172930 A1 discloses a catalytic wall-flow monolith filter for use in an emission treatment system comprising a porous substrate and a plurality of channels which are alternatingly open at the inlet end and closed at the outlet end or vice versa. The inlet zone comprises a first SCR catalyst distributed throughout the porous substrate, and a second SCR catalyst and an ammonia oxidation catalyst in the second zone. The ammonia oxidation catalyst is present in the form of a washcoat, and the second SCR catalyst is present as a coating over the ammonia oxidation catalyst. The first and the second SCR catalysts can be an oxide of a base metal, a molecular sieve, a metal exchanged molecular sieve or a mixture thereof. The base metal can be selected from the group consisting of cerium (Ce), chromium (Cr), cobalt (Co), copper (Cu), iron (Fe), manganese (Mn), molybdenum (Mo), nickel (Ni), tungsten (W), vanadium (V), and mixtures thereof. If the SCR catalyst is an oxide of a base metal, oxides of vanadium supported on a refractory metal oxide such as alumina, silica, zirconia, titania and ceria are preferred. If the SCR catalyst is a molecular sieve, it preferably deals with a small-pore, medium-pore or large-pore zeolite. Most preferably, the zeolite is selected from CHA, BEA, FAU, LTA, MFI and MOR framework types, and it is promoted with a transition metal from the groups VB, VIB; VIIB, VIIIB, IB and IIB, preferably Cu or Fe.

US 2008/202107 A1 discloses selective catalytic reduction (SCR) filters that effectively provide simultaneous treatment of particulate matter and NOx. Provided also are methods for reducing NOx concentration and particulate matter in a diesel engine exhaust by using the SCR filters. The SCR filter can include a fiber matrix wall flow filter comprising a plurality of non-woven inorganic fibers and a chabazite molecular sieve SCR catalyst on the fiber matrix wall flow filter. The non-woven inorganic fibers of the fiber matrix wall flow filter can be any suitable fiber as long as the fibers can have thermal tolerance under emission treatment processes. Thus, the fiber matrix wall flow filter containing the non-woven inorganic fibers can have one or more properties of a high melting point, low heat conductance, low coefficient of thermal expansion, an ability to withstand thermal and vibrational shock, a low density, a high porosity, and a high permeability. Suitable non-woven inorganic fibers include alumina fibers, silica fibers, mullite fibers, silicon carbide fibers, aluminosilicate fibers, aluminum borosilicate fibers, or the like. The chabazite molecular sieve used as the SCR catalyst is hydrophobic. By coating the fiber matrix wall flow filter with the chabazite molecular sieve SCR catalyst, the lower specific heat capacity of this filter can provide faster light-off, better conversions at low temperature for NOx control by the SCR reaction, and high temperature stability, when compared with conventional ceramic wall flow filters. Preferably, the chabazite is ion-exchanged with a transition metal, preferably copper. US 2008/202107 A1 is silent about an ASC catalyst layer.

WO 2016/205509 A1 discloses catalysts having a blend of platinum on a support with low ammonia storage with an SCR catalyst. The support material can be a siliceous support, and the siliceous support can comprise a silica or a zeolite with silica-to-alumina ratio of at least 100. The SCR catalyst is preferably a Cu-SCR catalyst or a Fe-SCR catalyst comprising of a molecular sieve and copper or iron, respectively. The molecular sieve can be an aluminosilicate, an aluminophosphate, a silico-aluminophosphate, or mixtures thereof. The catalysts are coated onto substrates selected from a honeycomb structure, an extruded substrate, or a metallic substrate. Preferably, the substrate is a ceramic substrate. The ceramic substrate can be made of a refractory material such as cordierite, cordierite-a alumina, a-alumina, silicon carbide, silicon nitride, zirconia, mullite, spodumene, alumina-silica magnesia, zirconium silicate, sillimanite, magnesium silicates, zircon, petalite, aluminosilicates and mixtures thereof. Wall flow substrates may also be formed of ceramic fiber composite materials, such as those formed from cordierite and silicon carbide.

WO 2019/116268 A1 discloses catalysts that are similar to those of WO 2016/205509 A1 with the major difference that in WO 2019/116268 A1, the support material comprises silica, titania, and/or Me-doped alumina or titania, wherein Me comprises a metal selected from tungsten, manganese, iron, bismuth, barium, lanthanum, cerium, zirconium, or mixtures thereof. The substrates to be used in WO 2019/116268 A1 are the same as those in WO 2016/205509 A1 with the exception that wall flow substrates formed of ceramic fiber composite materials are not mentioned.

EP 1 876 331 A2 discloses a device for the reduction of nitrogen oxides in the exhaust gas of combustion engines with the help of ammonia and/or reducing agents. It comprises a first catalyst element with selective catalytic reduction (SCR) activity and a downstream second catalyst element with honeycomb-shaped cross-section. The downstream catalyst element forms individual flow channels having a zone with SCR-activity and a zone with ammonia-oxidation activity in an alternating manner along the flow direction. The first catalyst element with SCR activity is a zeolite selected from ZSM-5 and/or OSI and/or EPI and/or AEN and/or MFI and/or FAU and/or BEA. The catalyst having ammonia oxidation activity preferably comprises platinum and/or palladium. The second catalyst element is a multi-layered catalyst, and a bulk catalyst that is manufactured by extrusion. The different active zones are produced in the flow channels during the extrusion process. The second catalyst element and the layers are bulk catalyst layers or are coated with the catalyst material. The coating is applied on the metal, ceramic carrier, glass, ceramic and/or silicate mats. The device disclosed in EP 1 876 331 A2 is particularly suitable for reducing NOx and ammonia slip while avoiding the formation of laughing gas N₂O.

US 2010/111796 A1 discloses a catalyst system including an upstream zone effective to catalyze the conversion of a mixture of NOₓ and NH₃ to N₂, and a downstream zone effective for the conversion of ammonia to N₂ in the presence or absence of NOₓ. In an embodiment, a method for preparing a catalyst system includes: first coating one end of a substrate along at least 5% of its length with an undercoat washcoat layer containing a material composition effective to catalyze the removal of ammonia; second coating with an overcoat layer containing a material composition effective to catalyze the conversion of a mixture of NOₓ and NH₃ to N₂. A method for treating the exhaust gas stream is provided, which includes injecting ammonia or an ammonia precursor into an exhaust gas stream of a vehicle, passing the engine exhaust gas stream containing NOₓ and NH₃ through the upstream zone of a catalyst system to remove NOₓ and then passing the exhaust gas stream through the downstream zone of the catalyst system to remove NH₃, as well as other oxidizable species such as hydrocarbons and CO.

The substrate is preferably a honeycomb substrate. The material composition effective to catalyze ammonia comprises a precious metal component dispersed on support particles, preferably platinum. The support particles may comprise a refractory metal oxide containing alumina, silica, zirconia, titania, ceria, and physical mixtures or chemical combinations thereof, including atomically doped combinations. The material composition effective to catalyze the conversion of a mixture of NOₓ and NH₃ preferably comprises at least one molecular sieve selected from FAU, MFI, MOR, BEA and CHA, most preferably CHA. Even more preferred, the CHA is ion-exchanged with copper, iron, or a mixture of copper and iron.

US 2010/080737 A1 provides an exhaust gas treatment catalyst capable of reducing ammonia leakage rate while keeping a sufficient NOₓ removal efficiency, said catalyst comprising a coating layer and a catalyst base material, wherein said coating layer has a decreased thickness relative to that of a catalyst base material; and an exhaust gas treatment system using the same. In the exhaust gas treatment catalyst for catalytically removing nitrogen oxides from an exhaust gas by using ammonia as a reducing agent and simultaneously decomposing and removing unreacted ammonia, a coating layer comprising platinum supported on titania is formed on a surface of a porous catalyst base material comprising titania and at least one compound selected from oxides of vanadium (V), oxides of tungsten (W) and oxides of molybdenum (Mo). The porous catalyst base material preferably is a honeycomb substrate.

The prior art provides several catalytic articles that simultaneously reduce NOₓ and oxidize excess ammonia to nitrogen and water. However, the catalytic articles known so far do not sufficiently address the problems of high catalyst weight and slow heating. Catalysts which have a high weight and/or which heat up slowly require more time and/or fuel to heat up to their operation temperature. The present invention provides catalytic articles with a low weight which heat up fast enough to their operation temperature during cold start and show a better performance with regard to ammonia conversion and NOx selectivity.

### Problem to be Solved by the Invention

It is an object of the present invention to provide a catalytic article for the removal of nitrogen oxides and ammonia from exhaust gas of lean combustion engines which heats up quickly to its operation temperature and shows a better performance. Another aim of the present invention is to provide a system for the purification of exhaust gases emitted from lean combustion engines.

### Solution of the Problem

The aim to provide a catalytic article for the removal of nitrogen oxides and ammonia from exhaust gas of lean combustion engines is solved by a catalytic article comprising
a) a corrugated glass fiber substrate,
b) a first washcoat, comprising at least one platinum group metal and/or at least one platinum group metal oxide, supported on a refractory metal oxide support, and optionally at least one binder, wherein said first washcoat is affixed in the walls of the corrugated glass fiber substrate, such that areas consisting of particles of the first washcoat alternate with void spaces, and
c) a second washcoat, comprising an SCR catalytically active composition and optionally at least one binder, wherein the majority of said second washcoat is located inside the walls of the corrugated glass fiber substrate, and wherein said second washcoat covers the areas consisting of particles of the first washcoat and the void spaces.

It has been found that the catalytic article for the removal of nitrogen oxides and ammonia from exhaust gas of lean combustion engines according to the present invention heats up quickly to its operation temperature and shows a better ammonia oxidation performance.

The catalytic article for the removal of nitrogen oxides and ammonia from exhaust gas of lean combustion engines and the method for its manufacture are explained below, with the invention encompassing all the embodiments indicated below, both individually and in combination with one another.

“Upstream” and “downstream” are terms relative to the normal flow direction of the exhaust gas in the exhaust pipeline. A “zone or catalytic article 1 which is located upstream of a zone or catalytic article 2” means that the zone or catalytic article 1 is positioned closer to the source of the exhaust gas, i.e., closer to the motor, than the zone or catalytic article 2. The flow direction is from the source of the exhaust gas to the exhaust pipe. Accordingly, in this flow direction the exhaust gas enters each zone or catalyst at its inlet end, and it leaves each zone or catalyst at its outlet end.

The “inlet end” of a catalytic article is the end which is directed towards the combustion source, and the “outlet end” is the end directed to the exhaust pipe.

A “catalyst carrier substrate”, also just called a “carrier substrate” is a support to which a catalytically active composition is affixed and shapes the final catalyst. The carrier substrate is thus a carrier for the catalytically active composition. In the present invention, the catalyst carrier substrate is a corrugated glass fiber substrate.

A “catalytically active composition” is a substance or a mixture of substances which is capable to convert one or more components of an exhaust gas into one or more other components. An example of such a catalytically active composition is, for instance, an oxidation catalyst composition which is capable of converting volatile organic compounds and carbon monoxide to carbon dioxide or ammonia to nitrogen oxides. Another example of such a catalyst is, for example, a selective reduction catalyst (SCR) composition which is capable of converting nitrogen oxides to nitrogen and water. In the context of the present invention, an SCR catalyst is a catalyst comprising a carrier substrate and a washcoat comprising an SCR catalytically active composition. An ammonia slip catalyst (ASC) is a catalyst comprising a carrier substrate, a washcoat comprising an oxidation catalyst, and a washcoat comprising an SCR catalytically active composition. The catalytic article according to the present invention is an ammonia slip catalyst. As explained above, such a catalyst is capable of oxidizing ammonia to nitrogen oxides and of converting the thus formed nitrogen oxides to N₂. Thus, an ASC combines the NH₃ oxidation function with an SCR function: ammonia entering the ASC is partially oxidized to NO. The freshly oxidized NO and NH₃ inside the ASC, which is not yet oxidized, can consequently react to N₂ following the usual SCR reaction schemes.

A “support material” is a material to which a catalytically active composition is affixed.

A “binder” is a material or substance that holds or draws other materials together to form a cohesive whole. The cohesive whole may be formed mechanically, chemically, by adhesion or by cohesion.

A “washcoat” as used in the present invention is an aqueous suspension of a catalytically active composition, supported on a support material, and optionally at least one binder. In the context of the present invention, the first and second washcoat may or may not, independently from one another, comprise a binder. If both washcoats comprise at least one binder, these washcoats may comprise the same or different binders.

In a preferred embodiment, the first and the second washcoat comprise at least one binder.

A washcoat which has been affixed to a catalyst carrier substrate is called a “coating”. It is also possible to affix two or more washcoats to the carrier substrate. The skilled person knows that affixing two or more washcoats onto one single carrier substrate is possible by “layering” or by “zoning”, and it is also possible to combine layering and zoning. In case of layering, the washcoats are affixed successively onto the carrier substrate, one after the other. The washcoat that is affixed first and thus in direct contact with the carrier substrate represents the “first layer”, and the washcoat that is affixed second it the “second layer”. In case of zoning, a first washcoat is affixed onto the carrier substrate from a first face side A of the carrier substrate towards the other face side B, but not over the entire length of the carrier substrate, but only to an endpoint which is between face sides A and B. Afterwards, a second washcoat is affixed onto the carrier, starting from face side B until an endpoint between face sides B and A. The endpoints of the first and the second washcoat need not be identical: if they are identical, then both washcoat zones are adjacent to one another. If, however, the endpoints of the two washcoat zones, which are both located between face sides A and B of the carrier substrate, are not identical, there can be a gap between the first and the second washcoat zone, or they can overlap. As mentioned above, layering and zoning can also be combined, if, for instance, one washcoat is applied over the entire length of the carrier substrate, and the other washcoat is only applied from one face side to an endpoint between both face sides.

In the context of the present invention, the “washcoat loading” is mass of the catalytically active composition per volume of the carrier substrate.

The skilled person knows that washcoats are prepared in the form of suspensions and dispersions.

Suspension and dispersions are heterogeneous mixtures comprising solid particles and a solvent. The solid particles do not dissolve, but get suspended throughout the bulk of the solvent, left floating around freely in the medium. If the solid particles have an average particle diameter of less than or equal to 1 μm, the mixture is called a dispersion; if the average particle diameter is larger than 1 μm, the mixture is called a suspension. Washcoats in the sense of the present invention comprise a solvent, usually water, and solvent particles represented by particles of one or more the catalytically active compositions, and optionally particles of at least one binder as described above. This mixture is often referred to as the “washcoat slurry”. The slurry is applied to the carrier substrate and subsequently dried to form the coating as described above. In the context of the present invention, the term “washcoat suspension” is used for mixtures of solvents, particles of one or more catalytically active compositions, and optionally particles of at least one binder, irrespective of the individual or average particle sizes. This means that in “washcoat suspensions” according to the present invention, the size of individual particles as well as the average particle size of the one or more catalytically active solid particles can be less than 1 μm, equal to 1 μm and/or larger than 1 μm.

The term “mixture” as used in the context of the present invention is a material made up of two of more different substances which are physically combined and in which each ingredient retains its own chemical properties and makeup. Despite the fact that there are no chemical changes to its constituents, the physical properties of a mixture, such as its melting point, may differ from those of the components.

A “catalyst”, also called “catalytic article” or “brick”, comprises of a catalyst carrier substrate and a washcoat, wherein the washcoat comprises a catalytically active composition and optionally at least one binder.

A “device” as used in the context of the present invention is a piece of equipment designed to serve a special purpose or perform a special function. The catalytic devices according to the present invention serve the purpose and have the function to remove both nitrogen oxides and ammonia from the exhaust gas of lean combustion engines. A “device” as used in the present invention may consist of one or more catalyst, also called “catalytic articles” or “bricks” as defined above.

The carrier substrate, also called “substrate monolith” according to the present invention is a corrugated glass fiber substrate. The substrate has a wall density of at least 50 g/l but not more than 150 g/l and a porosity of at least 50%. The substrate monolith consists of sheets of high silica content glass or a sheet of E-glass fiber. High silica content glass sheets may optionally comprise a layer of TiO₂ or diatomaceous earth. These corrugated glass fiber sheets typically are nonwovens. Nonwovens are generally defined as loose materials or sheet structures made of textile or non-textile fibers or filaments, whose cohesion is given by the adhesion inherent in the fibers. In this context, “filament” is the term for fibers of essentially unlimited length. In contrast, woven fabrics are textile fabrics made of threads crossed at right angles or nearly at right angles. The threads are held together by precisely this right-angled or nearly right-angled interlacing, whereby the aforementioned type of interlacing is generally referred to as “weaving”. Nonwovens, for instance the corrugated substrates of the present invention, are not woven. In a corrugated glass fiber substrate, flat sheets of the high silica content glass or E-glass fiber are corrugated. These corrugated sheets are also known as “waves”. Preferably, each of the corrugated sheets is provided with a flat liner made of the same material as the waves. The corrugated sheets, which are preferably provided with a liner, are then winded to form a corrugated glass fiber substrate of the desired diameter. In the present invention, the first and second washcoat are affixed to the waves and liners of the corrugated substrate. Corrugated substrates and their manufacture are disclosed in WO 2010/066345 A1, and the teaching thereof can be applied to the present invention without departing from the scope of the claims.

In the context of the present invention, the terms “nonwoven corrugated glass fiber substrate”, “corrugated glass fiber substrate” and “corrugated substrate” are used synonymously.

Known substrates are ceramic substrates on the one hand, and corrugated glass fiber substrates on the other hand. Ceramic substrates most commonly consist of cordierite or silicon carbide. Corrugated glass fiber substrates often comprise a titania layer applied onto the glass fiber material, and the one or more washcoats are applied onto the titania layer by coating or impregnating methods. The titania layer may optionally also comprise silica. Uncoated ceramic substrates have a high bulk density, and when they are coated with an SCR or ASC washcoat they get a high thermal mass. A high thermal mass means that it takes longer for the catalytic article to heat up to operational temperature during cold start of the engine and during fast transients, which limits the efficiency of the catalytic article in ammonia removal.

By contrast, the uncoated corrugated glass fiber substrates have a significantly lower bulk density and therefore, when coated with the same amount of an SCR or ASC washcoat than a ceramic substrate, they heat up faster to operational temperature. The term “uncoated corrugated glass fiber substrates”, as used in the present invention, refers to corrugated glass fiber substrates which may or may not comprise the titania layer mentioned above. A “coated corrugated glass fiber substrate” is a corrugated glass fiber substrate onto which one or more washcoats as described above have been applied. Preferably, the corrugated glass fiber substrates to be used in the present invention comprise a titania layer, more preferably a titania layer also comprising silica.

The “bulk density” as used in the present invention is the weight of a given substrate divided by its volume.

Bulk densities of uncoated corrugated substrates are in the range of 50 to 150 g/L of volume, preferably 70 to 120 g/L, more preferably 80 to 110 g/L.

Bulk densities of ceramic substrates, for instance substrates made of cordierite or silicon carbide, are in the range of larger than or equal to 150 g/L, most typically larger than 250 g/L.

In the context of the present invention, the terms “heat capacity” and “thermal mass” are used synonymously.

The first washcoat of the catalytic article according to the invention comprises a first washcoat comprising at least one platinum group metal and/or at least one platinum group metal oxide supported on a refractory metal oxide support, and optionally at least one binder. Said first washcoat is affixed in the walls of the corrugated glass fiber substrate such that areas consisting of particles of the first washcoat alternate with void spaces. In the context of the present invention, the first washcoat, after having been affixed in the walls of the corrugated glass fiber substrate, consists of unconnected particles of said washcoat and of void spaces. The void spaces are areas where no particles of the first washcoat are affixed in the walls of the corrugated glass fiber substrate. These void spaces alternate with areas where washcoat particles are affixed in the walls of the corrugated glass fiber substrate. As a result, the first washcoat has the shape of islands, formed by particles which are affixed in the walls of the glass fibers which form the walls of the corrugated substrate. Said islands alternate with void areas of the network of glass fibers of the corrugated substrate, where no particles of the first washcoat are present.

The first washcoat acts as the oxidation catalyst within the ASC according to the invention. The location of the first washcoat in the walls of the corrugated substrate can be checked by Scanning Electron Microscopy (SEM).

The oxidation catalyst comprised in the first washcoat is a platinum group metal, a platinum group metal oxide, a mixture of two or more platinum group metals, a mixture of two or more platinum group metal oxides, or a mixture of at least one platinum group metal and at least one platinum group metal oxide. Platinum group metals, hereinafter abbreviated as PGM, are ruthenium, rhodium, palladium, osmium, iridium and platinum. In the present invention, PGMs are selected from ruthenium, rhodium, palladium, iridium and platinum. The skilled person knows the respective oxides of these platinum group metal oxides and can apply them in the context of the present invention without departing from the scope of the claims. Preferably, the oxidation catalyst is a platinum group metal or a mixture of two or more platinum group metals. More preferably, the oxidation catalyst is selected from platinum and mixtures of platinum and palladium or platinum and rhodium. The refractory metal oxide support can be selected from titania, activated alumina, ceria, silica, non-molecular sieve silica-alumina, zirconia, and mixtures thereof. In a preferred embodiment, the refractory metal oxide support is titania.

The at least one platinum group metal and/or at least one platinum group metal oxide can be supported on the refractory metal oxide support by preparing an aqueous slurry of the refractory metal oxide support particles, followed by impregnating these particles with a water-dispersible or water-soluble precursor of the at least one platinum group metal and/or at least one platinum group metal oxide. The skilled person knows how to prepare such platinum group metals or platinum group metal oxides on a refractory metal oxide support and can apply this knowledge without departing from the scope of the claims.

Most preferred, the at least one platinum group metal and/or at least one platinum group metal oxide supported on a refractory metal oxide support is platinum supported on titania.

The washcoat loading of the first washcoat is between 10 to 100 g/L, preferably 20 to 75 g/L. The PGM concentration within the washcoat is between 0.01766 and 0.88287 g/l, (0.5 to 25 g/ft³), preferably between 0.05297 and 0.35315 g/L (1.5 to 10 g/ft³).

The second washcoat of the catalytic article according to the invention comprises an SCR catalytically active composition and optionally at least one binder. Said second washcoat is affixed to the corrugated glass fiber substrate in such a manner that it covers the areas consisting of particles of the first washcoat and the void spaces. As described above, the first washcoat forms “islands” and void spaces, and the second washcoat covers the “islands” and the void spaces. As a result, both the first and the second washcoat are affixed to the network of the nonwoven glass fibers which form the walls of the corrugated substrate. The majority of the second washcoat is located inside the walls of the corrugated glass fiber substrate. The term “the majority of the second washcoat is located inside the walls of the corrugated glass fiber substrate” means that more than or equal to 50% of the second washcoat are located inside the walls of the corrugated glass fiber substrate, more preferably more than or equal to 60%, even more preferably more than or equal to 70%, still more preferably more than or equal to 80% and most preferably more than or equal to 90%. The location of the second washcoat inside the walls of the corrugated substrate can be checked by SEM.

The SCR catalytically active composition is selected from one or more molecular sieves. A molecular sieve is a material with pores, i.e., with very small holes, of uniform size. These pore diameters are similar in size to small molecules, and thus large molecules cannot enter or be adsorbed, while smaller molecules can. In the context of the present invention, a molecular sieve can be zeolitic or non-zeolitic. Zeolites are made of corner-sharing tetrahedral SiO₄ and AlO₄ units. They are also called “aluminosilicates”.

As used herein, the terminology “non-zeolitic molecular sieve” refers to corner-sharing tetrahedral frameworks wherein at least a portion of the tetrahedral sites are occupied by an element other than silicon or aluminum. If a portion, but not all silicon atoms are replaced by phosphorous atoms, it deals with so-called “silico aluminophosphates” or “SAPOs”. If all silicon atoms are replaced by phosphorous, it deals with aluminophosphates or “AlPOs”.

A “zeolite framework type”, also referred to as “framework type”, represents the corner-sharing network of tetrahedrally coordinated atoms. It is common to classify zeolites according to their pore size which is defined by the ring size of the biggest pore aperture. Zeolites with a large pore size have a maximum ring size of 12 tetrahedral atoms, zeolites with a medium pore size have a maximum pore size of 10 and zeolites with a small pore size have a maximum pore size of 8 tetrahedral atoms. Well-known small-pore zeolites belong in particular to the AEI, CHA (chabazite), ERI (erionite), LEV (levyne), AFX and KFI framework. Examples having a large pore size are zeolites of the faujasite (FAU) framework type and zeolite Beta (BEA).

A “zeotype” comprises any of a family of materials based on the structure of a specific zeolite. Thus, a specific “zeotype” comprises, for instance, aluminosilicates, SAPOs and AlPOs that are based on the structure of a specific zeolite framework type. Thus, for example, chabazite (CHA), the aluminosilicates SSZ-13, Linde R and ZK-14, the silicoaluminophosphate SAPO-34 and the aluminophosphate MeAlPO-47 all belong to the chabazite framework type. The skilled person knows which aluminosilicates, silico aluminophosphates and aluminophosphates belong to the same zeotype. Furthermore, zeolitic and non-zeolitic molecular sieves belonging to the same zeotype are listed in the database of the International Zeolite Association (IZA). The skilled person can use this knowledge and the IZA database without departing from the scope of the claims.

In a preferred embodiment of the present invention, the molecular sieve is a small-pore crystalline aluminosilicate zeolite.

Suitable crystalline aluminosilicate zeolites are, for instance, zeolite framework type materials chosen from ACO, AEI, AEN, AFN, AFT, AFX, ANA, APC, APD, ATT, BEA, BIK, CDO, CHA, DDR, DFT, EAB, EDI, EPI, ERI, ESV, ETL, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON and mixtures and intergrowths that contain at least one of these framework types.

In one embodiment of the present invention, the crystalline small-pore aluminosilicate zeolites have maximum pore size of eight tetrahedral atoms and are chosen from AEI, AFT, AFX, CHA, DDR, ERI, ESV, ETL, KFI, LEV, UFI and mixtures and intergrowths thereof. In another embodiment, the zeolites are chosen from AEI, BEA, CHA, AFX and mixtures and intergrowths that contain at least one of these framework types. In a particularly preferred embodiment, the zeolite is AEI. In another particularly preferred embodiment, the zeolite is CHA.

An “intergrowth” of a zeolite comprises at least two different zeolite framework types or two different zeolite compositions of the same framework type.

In an “overgrowth” zeolite, one framework structure grows on top of the other one. Thus, “overgrowth” represents a species of “intergrowth”, and “intergrowth” is the genus.

In the present invention, zeolitic and non-zeolitic molecular sieves to be used as SCR catalysts or as a component of an SCR catalyst composition contain a transition metal. The transition metal is preferably selected from copper, iron and mixtures thereof.

Crystalline aluminosilicate zeolites to be used as SCR catalytically active compositions in the present invention have a silica-to-alumina ratio of 5 to 100, preferably 10 to 50. The silica-to-alumina ratio, SiO₂:Al₂O₃, is referred to hereinafter as “the SAR value” or “the SAR”.

Preferably, the crystalline aluminosilicate zeolites to be used as SCR catalytically active compositions in the present invention are promoted with a transition metal selected from copper, iron, or mixtures of copper and iron.

In one embodiment, the zeolites are promoted with copper. Preferably, the copper to aluminum atomic ratio is in the range of between 0.005 to 0.555, more preferably between 0.115 to 0.445, even more preferably between 0.175 and 0.415. The skilled person knows how to adjust the amount of copper which is introduced during synthesis or via ion exchange to yield the desired copper to aluminum ratio. He can make use of this knowledge without departing from the scope of the claims.

In another embodiment, the zeolites are promoted with iron. Preferably, the iron to aluminum atomic ratio is in the range of between 0.005 to 0.555, more preferably between 0.115 to 0.445, even more preferably between 0.175 and 0.415. The skilled person knows how to adjust the amount of iron which is introduced during synthesis or via ion exchange to yield the desired iron to aluminum ratio. He can make use of this knowledge without departing from the scope of the claims.

In yet another embodiment, the zeolites are promoted with both copper and iron. Preferably, the (Cu+Fe):Al atomic ratio is in the range of between 0.005 to 0.555, more preferably between 0.115 to 0.445, even more preferably between 0.175 and 0.415.

In embodiments wherein the SCR catalytically active composition comprises two or more molecular sieves, the molecular sieves differ from one another in at least one of the following features:
they have different framework structures and/or
they belong to the same framework structure, but represent different zeotypes, and/or
they belong to the same framework type, but the first and the second compositions are selected from aluminosilicates and silico aluminophosphates, or aluminosilicates and aluminophosphates, or silico aluminophosphates and aluminophosphates, and/or
they are promoted with different transition metals, and/or
their transition metal amount is different, and/or
the aluminosilicates differ in their SAR values.

According to the definition of “two or more molecular sieves” as given above, it is, for instance, possible to use a mixture of AEI and CHA, which have the same SAR value and which are both promoted with the same amount of copper, because they differ in their framework structure.

Furthermore, two CHA aluminosilicate zeolites or two AEI aluminosilicate zeolites are also considered “different” if they have different SAR values, or if they are promoted with different amounts of copper, or if one is promoted with copper, and the other one is promoted with iron. In addition, two aluminosilicates having the CHA framework type are considered “different” if, for instance, one is SSZ-13 and the other one is ZK-14, even if they have the same SAR value and copper content, because they belong to different zeotypes.

These examples serve as illustrative examples. They are not to be considered as closed lists of “two or more molecular sieves”.

Preferably, the washcoat loading of the SCR catalytically active composition is between 100 and 230 g/L, preferably 120 to 180 g/L,

In embodiments of the present invention, the first and the second washcoat comprise, independently from one another, a binder. This means that
only the first washcoat comprises a binder, but the second washcoat does not; or
only the second washcoat comprises a binder, but the first washcoat does not; or
both the first and the second washcoat comprise a binder.

The binder can be selected from alumina, aluminum oxide-hydroxide, silica, non-zeolitic silica-alumina, naturally occurring clay, TiO₂, ZrO₂, CeO₂, SnO₂ and mixtures and combinations thereof. Preferably, the binder is selected from alumina, aluminum oxide-hydroxide, TiO₂, ZrO₂ and mixtures and combinations thereof.

Preferably, both the first and the second washcoat comprise a binder. The binders of the first and second washcoat can be the same or different from one another.

In other embodiments, neither the first nor the second washcoat comprises a binder. The refractory metal oxide support can be selected from titania, activated alumina, ceria, silica, non-molecular sieve silica-alumina, zirconia, and mixtures thereof.

It has been stated above that the first washcoat comprises at least one platinum group metal and/or at least one platinum group metal oxide, supported on a refractory metal oxide support, and optionally at least one binder. Some of the refractory metal oxides can act as a support material, but also as a binder. If a refractory metal oxide is used as a support material, it acts as a material to which a catalytically active material is affixed, thereby forming particles which contain the catalytically active material and the support material. By contrast, a binder holds or draws other materials together. Thus, when a refractory metal oxide is used as a binder, it holds or draws individual particles together, wherein the individual particles contain the catalytically active material and the support material.

The catalytic devices according to the present invention can be manufactured by processes known in the art. Powders of the SCR catalytically active compositions or the oxidation catalyst and optionally the at least one binder are mixed with water. Optionally, the mixture can be milled to adjust the particle sizes. The concentration of the solids in the respective washcoat is adjusted according to the desired washcoat loading. The first washcoat comprising at least one platinum group metal and/or at least one platinum group metal oxide, supported on a refractory metal oxide support, and optionally at least one binder, supported on a refractory metal oxide support, is then coated onto the corrugated glass fiber substrate in a direction perpendicular to the face sides A and B of the catalyst substrate. It can be coated top to bottom, preferably by coating the washcoat under pressure in the direction from the top face side to the bottom face side. Alternatively, the washcoat can be coated bottom to top, preferably by soaking it from the bottom face side to the top face side under reduced pressure. Subsequently, excess washcoat is removed either by sucking it out, preferably under reduced pressure, or by purging it out under pressure. Subsequently, the second washcoat comprising an SCR catalytically active composition and optionally at least one second binder is coated on the glass fiber substrate in the same manner. This means that the steps of preparing the respective washcoat slurry, applying it, and removing excess washcoat are repeated. Finally, the washcoated carrier substrate is dried and calcined in an oven. These processes are well known to the skilled person and can be applied in the context of the present invention without departing from the scope of the claims.

When the first and the second washcoat are coated onto the corrugated glass fiber substrate as described above, the particles of both washcoats are affixed to glass fibers of the nonwoven corrugated glass fiber substrate as described above. This means that particles of the first washcoat forms “islands” and void spaces, and the second washcoat covers the “islands” and the void spaces. As a result, both the first and the second washcoat are affixed to the network of the nonwoven glass fibers which form the walls of the corrugated substrate.

FIGS. 5a, 5b and 5c show SEM images of Example 1 according to the present invention. The images show that particles of the first and the second washcoat are affixed to the glass fibers of the nonwoven corrugated glass fiber substrate. The particles of the first washcoat are affixed so that areas consisting of particles of the first washcoat alternate with void spaces, and the second washcoat covers areas consisting of particles of the first washcoat and the void spaces.

The catalytic articles according to the present invention can be used in systems for the treatment of exhaust gases of lean-burn combustion engines. In particular, they can be used in systems for the removal of nitrogen oxides and ammonia from the exhaust gas of lean-burn combustion engines. In such systems, the catalytic article is preferably located immediately downstream of a catalytic article having an SCR functionality. The catalytic article having an SCR functionality can be a ceramic flow-through monolith, a ceramic wall-flow filter, or a corrugated substrate monolith, each coated with an SCR catalytically active substance, respectively.

The skilled person knows that the SCR reaction requires the presence of ammonia as a reductant. Ammonia may be supplied in an appropriate form, for instance in the form of liquid ammonia or in the form of an aqueous solution of an ammonia precursor, and added to the exhaust gas stream as needed via means for injecting ammonia or an ammonia precursor. Suitable ammonia precursors are, for instance urea, ammonium carbamate or ammonium formate. A widespread method is to carry along an aqueous urea solution and to and to dose it into the catalyst according to the present invention via an upstream injector and a dosing unit as required. Means for injecting ammonia, for example an upstream injector and a dosing unit, are well known to the skilled person and can be used in the present invention without departing from the scope of the claims.

The present invention thus also refers to a system for the purification of exhaust gases emitted from lean combustion engines, characterized in that it comprises, in the following order from upstream to downstream:
a) means for injection ammonia or an ammonia precursor solution into the exhaust gas stream,
b) a catalytic article having an SCR functionality, wherein said catalytic article having an SCR functionality is a ceramic flow-through monolith, a ceramic wall-flow filter, or a corrugated substrate monolith, and wherein the catalytic article is coated with an SCR catalytically active substance,
c) a catalytic article according to the present invention.

### BRIEF DESCRIPTION OF THE DRAWINGS

FIG. 1 shows the NH₃ conversion of Comparative Example 1 and Example 1

FIG. 2 shows the selectivity to NOₓ of Comparative Example 1 and Example 1

FIG. 3 shows the selectivity to N₂O of Comparative Example 1 and Example 1

FIGS. 4a and 4b show SEM images of Comparative Example 1 in two different magnifications. In FIG. 4 b, 1 shows the first washcoat, 2 shows the second washcoat, and 3 shows the cordierite substrate.

FIGS. 5a, 5b and 5c show SEM images of Example 1 in different magnifications. In FIG. 5c, 1 shows the particles of the first washcoat, 2 shows the second washcoat, and 3 shows glass fibers of the nonwoven corrugated glass fiber substrate.

### EMBODIMENTS

### Preparation of ASC Catalysts

Two substrates were coated with a bottom layer comprising an oxidation catalyst and a top layer comprising an SCR catalyst.

Both substrates were coated with identical oxidation and SCR catalysts, respectively. The washcoat loadings of the oxidation and the SCR catalysts were also identical.

### Oxidation Catalyst:

The oxidation catalyst consisted of 2 g/ft³ (0.0707 g/L) Pt, supported on TiO₂. AlO(OH) was used as a binder. The washcoat loading was 50 g/L.

### SCR Catalyst:

The SCR catalysts consisted of Cu-CHA with a SAR of 13 and a copper content of 5.5 wt.-%, calculated as CuO and based on the total weight of the zeolite. AlO(OH) was used as a binder. The washcoat loading was 150 g/L.

### Comparative Example 1

A flow-through cordierite monolith with 4/400 mil/cpsi was coated with the oxidation catalyst as the bottom layer and then with the SCR catalyst as the top layer.

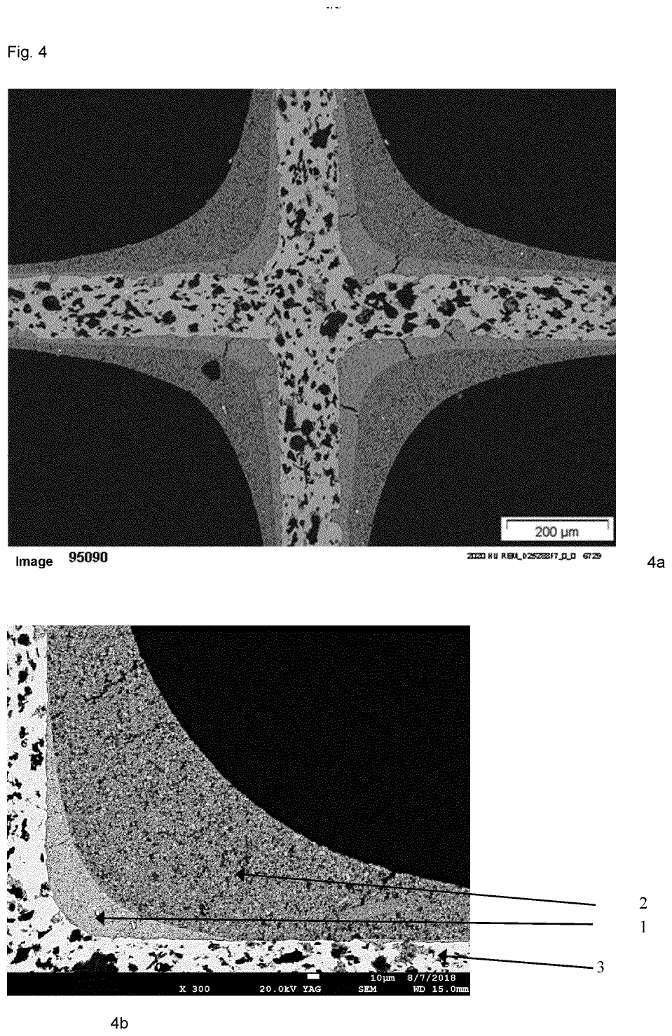

SEM images of Comparative Example 1 in two different magnifications are shown in FIGS. 4a and 4b.

### Example 1

A corrugated glass fiber substrate which was not pre-coated with TiO₂ and having a cpsi of 380 was coated with the oxidation catalyst as the bottom layer and then with the SCR catalyst as the top layer.

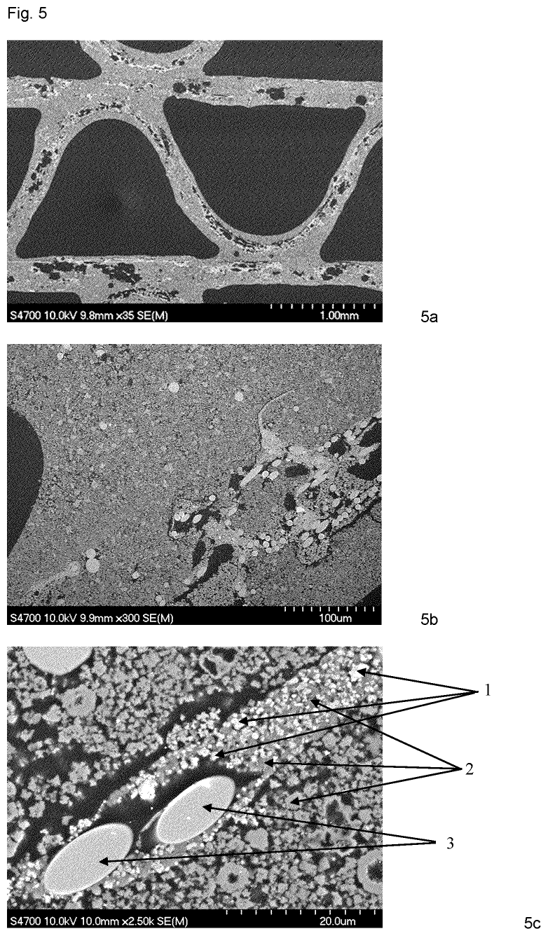

SEM images of Example 1 in different magnifications are shown in FIGS. 5a, 5b and 5c.

### Embodiment 1: Measurement of the NH₃ Conversion

The NH₃ conversion of Example 1 and Comparative Example 1 was measured under the following conditions:

200 ppm NH₃, 12% O₂, 4% H₂O, balance N₂ at the inlet, GHSV=250,000 h⁻¹. The ammonia slip at the outlet was measured by FTIR (Fourier transform infrared spectroscopy).

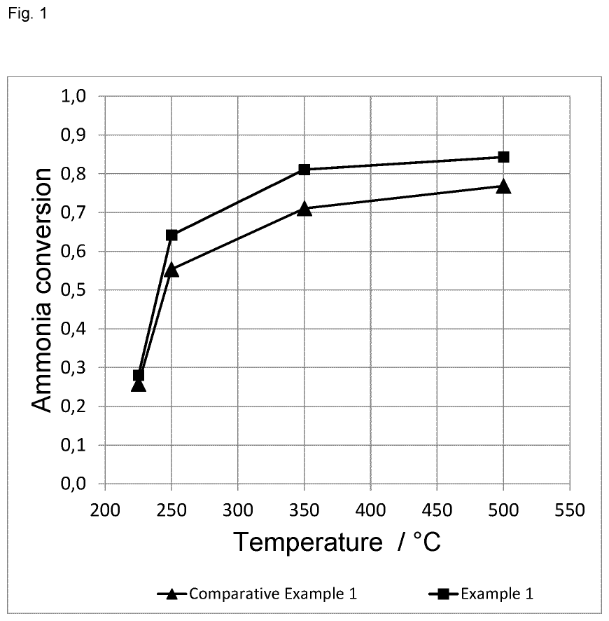

The results are shown in FIG. 1.

### Embodiment 2: Measurement of the Selectivity to NOₓ

The selectivity to NOₓ, i.e. the oxidation of NH₃ to NOₓ of Comparative Example 1 and of Example 1 was measured under the following conditions:

250 ppm NOₓ, 300 ppm NH₃, 12% O₂, 4% H₂O, balance N₂ at the inlet, GHSV=250,000 h⁻¹. The NOₓ concentration at the outlet was measured by FTIR.

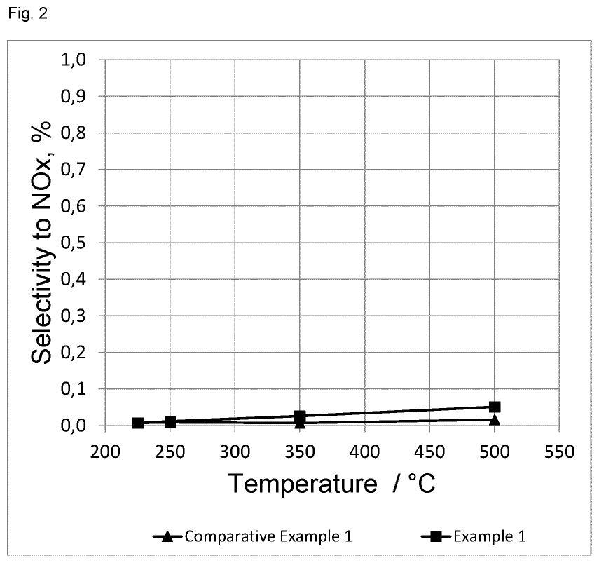

The results are shown in FIG. 2.

### Embodiment 3: Measurement of the Selectivity to N₂O

The selectivity to N₂O, i.e., the oxidation of NH₃ to N₂O of Comparative Example 1 and of Example 1 was measured under the following conditions:

250 ppm NOₓ, 300 ppm NH₃, 12% O₂, 4% H₂O, balance N₂ at the inlet, GHSV=250,000 h⁻¹. The N₂O concentration at the outlet was measured by FTIR.

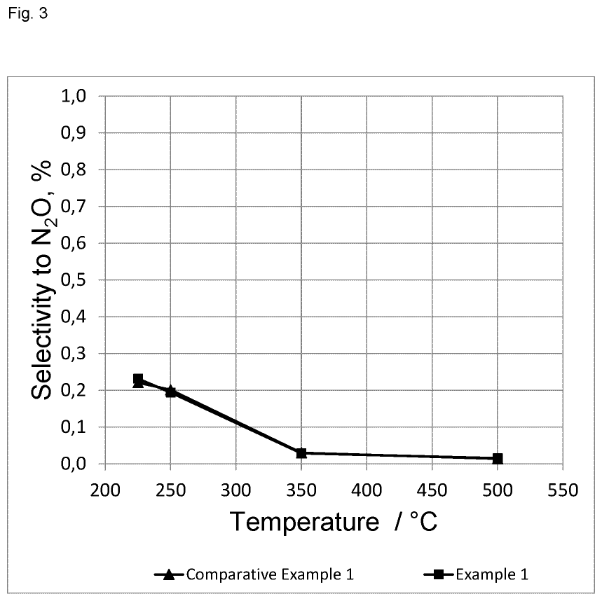

The results are shown in FIG. 3.

Table 1 shows the results of the measurements of the NH₃ conversion and the selectivity to NOx and N₂O.

| | NH₃ conversion [%] | | Selectivity to NOx [%] | | Selectivity to N₂O [%] | |
|---|---|---|---|---|---|---|
| Temperature | Comparative | | Comparative | | Comparative | |
| [° C.] | Example 1 | Example 1 | Example 1 | Example 1 | Example 1 | Example 1 |
| 225 | 17.8 | 12.7 | 0.0 | 1.0 | 23.5 | 22.7 |
| 250 | 55.5 | 57.9 | 1.3 | 1.1 | 20.3 | 20.3 |
| 350 | 73.8 | 80.4 | 2.0 | 1.9 | 2.4 | 2.55 |
| 550 | 76.8 | 84.7 | 3.3 | 4.9 | 1.2 | 1.5 |

1. A catalytic article comprising
a) a corrugated glass fiber substrate,
b) a first washcoat, comprising at least one platinum group metal and/or at least one platinum group metal oxide, supported on a refractory metal oxide support, and optionally at least one binder, wherein said first washcoat is affixed in the walls of the corrugated glass fiber substrate, such that areas consisting of particles of the first washcoat alternate with void spaces, and
c) a second washcoat, comprising an SCR catalytically active composition and optionally at least one binder, wherein the majority of said second washcoat is located inside the walls of the corrugated glass fiber substrate, and wherein said second washcoat covers the areas consisting of particles of the first washcoat and the void spaces.

2. The catalytic article according to claim 1, wherein the first washcoat comprises a platinum group metal, a platinum group metal oxide, a mixture of two or more platinum group metals, a mixture of two or more platinum group metal oxides, or a mixture of at least one platinum group metal and at least one platinum group metal oxide, wherein the platinum group metal is selected from ruthenium, rhodium, palladium, iridium, and platinum.

3. The catalytic article according to claim 1, wherein the refractory metal oxide support can be selected from titania, activated alumina, ceria, silica, non-molecular sieve silica-alumina, zirconia, and mixtures thereof.

4. The catalytic device according to claim 1, wherein the SCR catalytically active composition is selected from molecular sieves.

5. The catalytic device according to claim 4, wherein the molecular sieve is a crystalline aluminosilicate zeolite selected from ACO, AEI, AEN, AFN, AFT, AFX, ANA, APC, APD, ATT, BEA, BIK, CDO, CHA, DDR, DFT, EAB, EDI, EPI, ERI, ESV, ETL, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON, and mixtures and intergrowths that contain at least one of these framework types.

6. The catalytic device according to claim 4, wherein the crystalline aluminosilicate zeolite has a SAR value of 5 to 100.

7. The catalytic article according to claim 4, wherein the crystalline aluminosilicate zeolite is promoted with copper, and wherein the copper to aluminum atomic ratio is in the range of between 0.005 to 0.555.

8. The catalytic article according to claim 4, wherein the aluminosilicate zeolite is promoted with iron, and wherein the iron to aluminum atomic ratio is in the range of between 0.005 to 0.555.

9. The catalytic article according to claim 4, wherein the aluminosilicate zeolite is promoted with both copper and iron, and wherein the (Cu+Fe):Al atomic ratio is in the range of between 0.005 to 0.555.

10. The catalytic article according to claim 1, wherein the first and the second washcoat comprise, independently from one another, a binder, wherein the binder is selected from alumina, silica, non-zeolitic silica-alumina, naturally occurring clay, TiO₂, ZrO₂, CeO₂, SnO₂, and mixtures and combinations thereof.

11. A system for the purification of exhaust gases emitted from lean combustion engines comprising, in the following order from upstream to downstream:
a) means for injection ammonia or an ammonia precursor solution into the exhaust gas stream,
b) a catalytic article having an SCR functionality, wherein said catalytic article having an SCR functionality is a ceramic flow-through monolith, a ceramic wall-flow filter, or a corrugated substrate monolith, and wherein the catalytic article is coated with an SCR catalytically active substance,
c) a catalytic article according to the present invention.
